(19) United States
(12) Patent Application Publication
(10) Pub. No.: US 2003/0200336 A1
(43) Pub. Date: Oct. 23, 2003

(54) Apparatus and method for the delivery of multiple sources of media content

(76) Inventors: Suparna Pal, Santa Clara, CA (US); Keith Deutsch, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/367,282

(22) Filed: Feb. 14, 2003

Related U.S. Application Data
(60) Provisional application No. 60/357,332, filed on Feb. 15, 2002.
(60) Provisional application No. 60/359,152, filed on Feb. 20, 2002.

(51) Int. Cl. G06F 15/16

(52) U.S. Cl. 709/246; 709/231

(57) ABSTRACT

In one embodiment, an apparatus referred to as an intelligent media content exchange (M-CE), comprises a plurality of line cards coupled to a bus. One of the line cards is adapted to handling acquisition of at least two different types of media content from different sources. Another line card is adapted to process the at least two different types of media content in order to integrate the two different types of media content into a single stream of media content.

This Application claims the benefit of priority on U.S. Provisional Patent Application No. 60/357,332 filed Feb. 15, 2002 and U.S. Provisional Patent Application No. 60/359,152 filed Feb. 20, 2002.

### FIELD

Embodiments of the invention relate to the field of communications, in particular, to a system, apparatus and method for receiving different types of media content and transcoding the media content for transmission as a single media stream over a delivery channel of choice.

### GENERAL BACKGROUND

Recently, interactive multimedia systems have been growing in popularity and are fast becoming the next generation of electronic information systems. In general terms, an interactive multimedia system provides its user an ability to control, combine, and manipulate different types of media data such as text, sound or video. This shifts the user's role from an observer to a participant.

Interactive multimedia systems, in general, are a collection of hardware and software platforms that are dynamically configured to deliver media content to one or more targeted end-users. These platforms may be designed using various types of communications equipment such as computers, memory storage devices, telephone signaling equipment (wired and/or wireless), televisions or display monitors. The most common applications of interactive multimedia systems include training programs, video games, electronic encyclopedias, and travel guides.

For instance, one type of interactive multimedia system is cable television services with computer interfaces that enable viewers to interact with television programs. Such television programs are broadcast by high-speed interactive audiovisual communications systems that rely on digital data from fiber optic lines or digitized wireless transmissions.

Recent advances in digital signal processing techniques and, in particular, advancements in digital compression techniques, have led to new applications for providing additional digital services to a subscriber over existing telephone and coaxial cable networks. For example, it has been proposed to provide hundreds of cable television channels to subscribers by compressing digital video, transmitting the compressed digital video over conventional coaxial cable television cables, and then decompressing the video at the subscriber's set top box.

Another proposed application of this technology is a video on demand (VoD) system. For a VoD system, a subscriber communicates directly with a video service provider via telephone lines to request a particular video program from a video library. The requested video program is then routed to the subscriber's personal computer or television over telephone lines or coaxial television cables for immediate viewing. Usually, these systems use a conventional cable television network architecture or Internet Protocol (IP) network architecture.

As broadband connections acquire a larger share of online users, there will be an ever-growing need for real-time access, control, and delivery of live video, audio and other media content to the end-users. However, media content may be delivered from a plurality of sources using different transmission protocols or compression schemes such as Motion Pictures Experts Group (MPEG), Internet Protocol (IP), or Asynchronous Transfer Mode (ATM) protocol for example.

Therefore, it would be advantageous to provide a system, an apparatus and method that would be able to handle and transform various streams directed at an end-user into a single media stream.

### BRIEF DESCRIPTION OF THE DRAVVINGS

The invention may best be understood by referring to the following description and accompanying drawings that are used to illustrate embodiments of the invention.

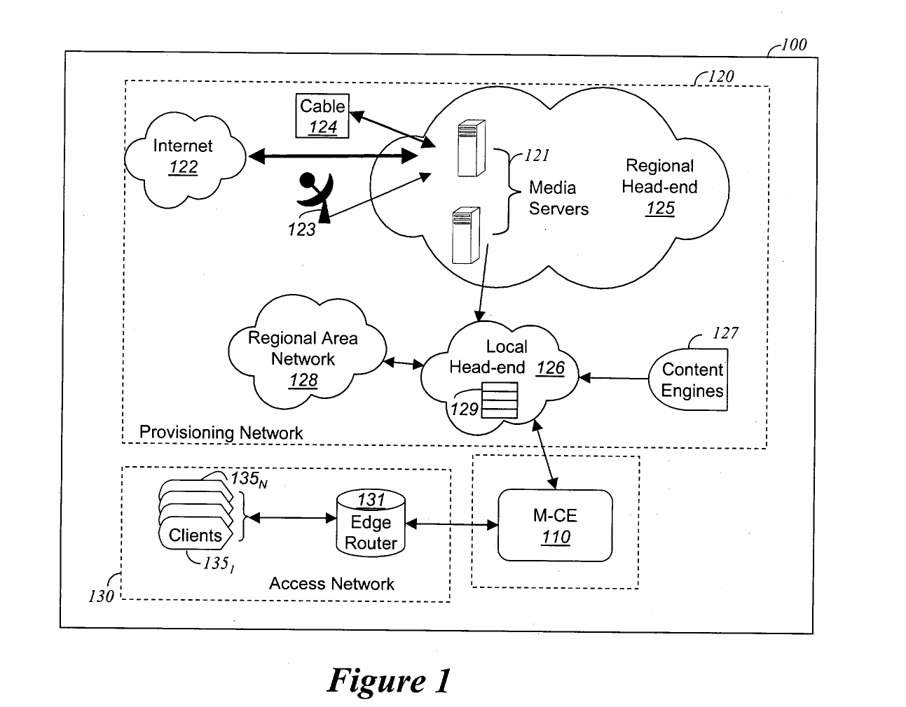

FIG. 1 is a schematic block diagram of the deployment view of a media delivery system in accordance with one embodiment of the invention.

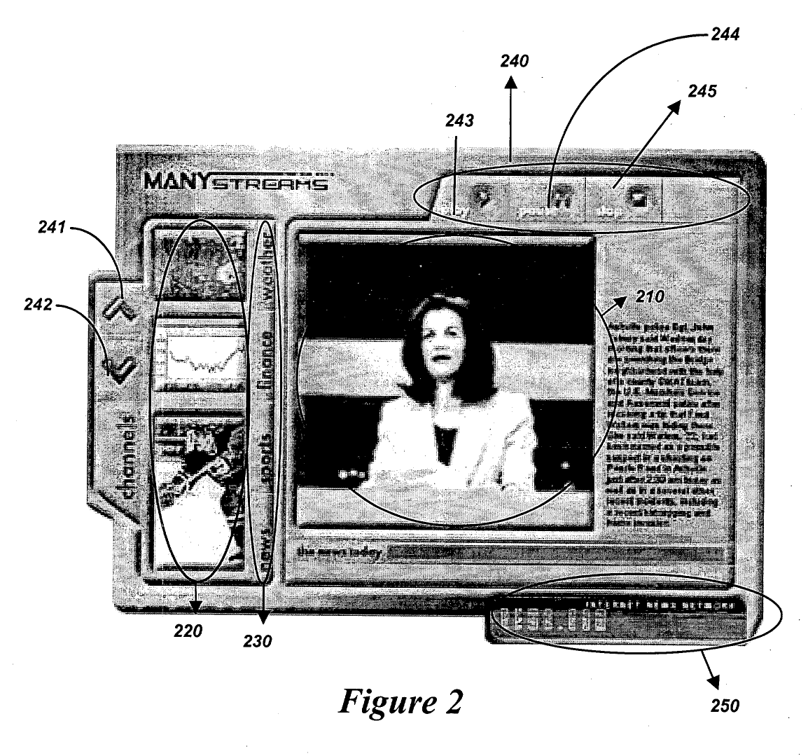

FIG. 2 is an exemplary diagram of screen display at a client based on media content received in accordance with one embodiment of the invention.

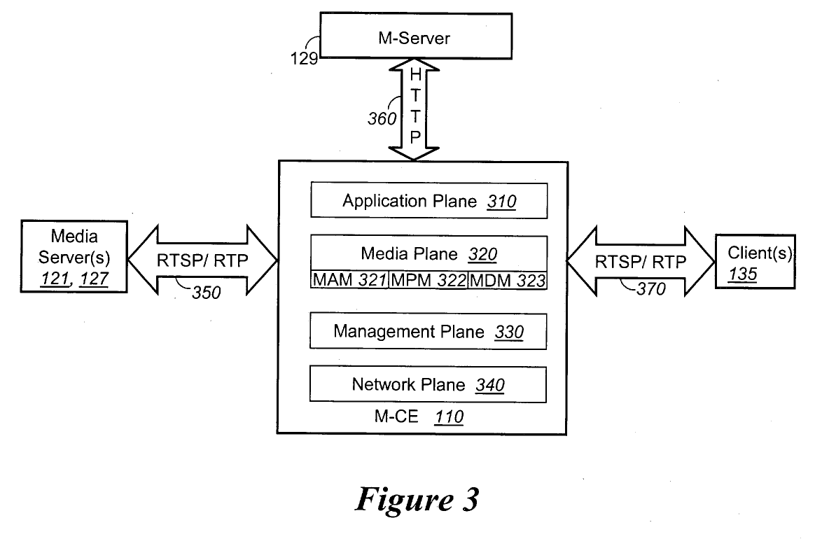

FIG. 3 is an exemplary diagram of an intelligent media content exchange (M-CE) in accordance with one embodiment of the invention.

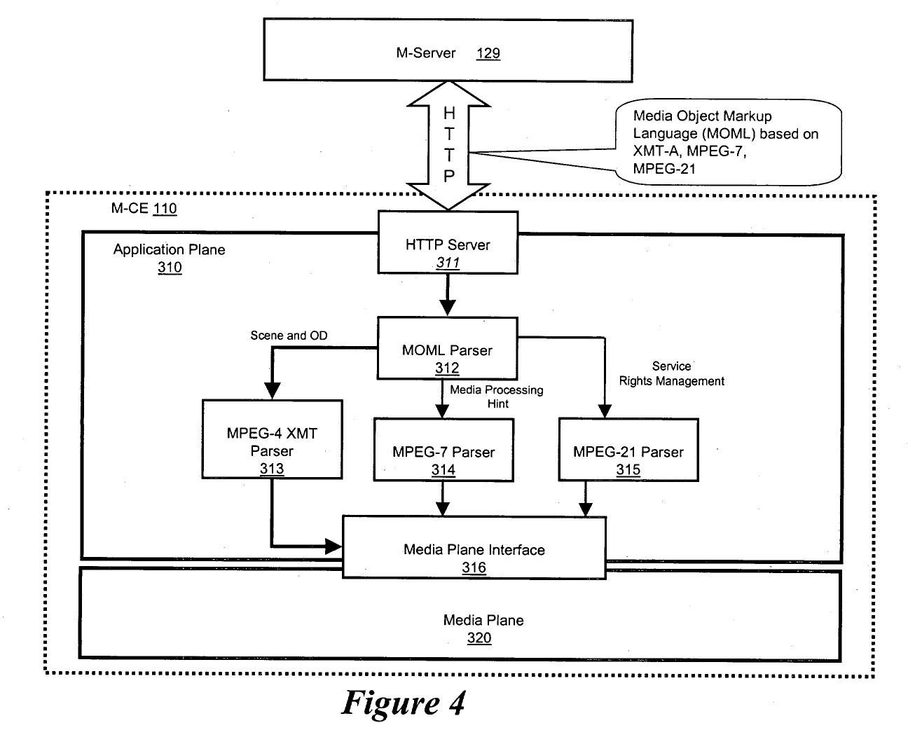

FIG. 4 is an exemplary diagram of the functionality of the application plane deployed within the M-CE of FIG. 3.

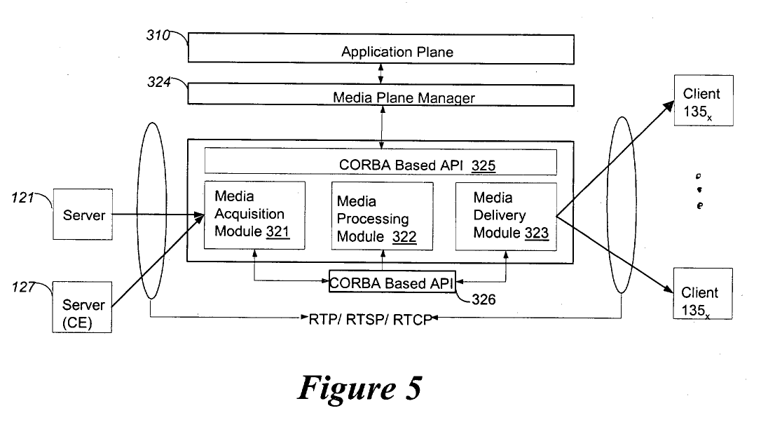

FIG. 5 is an exemplary diagram of the functionality of the media plane deployed within the M-CE of FIG. 3.

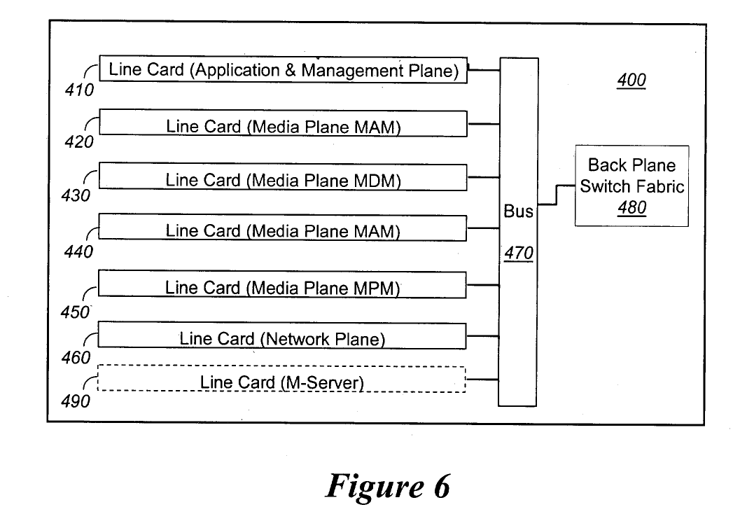

FIG. 6 is an exemplary block diagram of a blade based media delivery architecture in accordance with one embodiment of the invention.

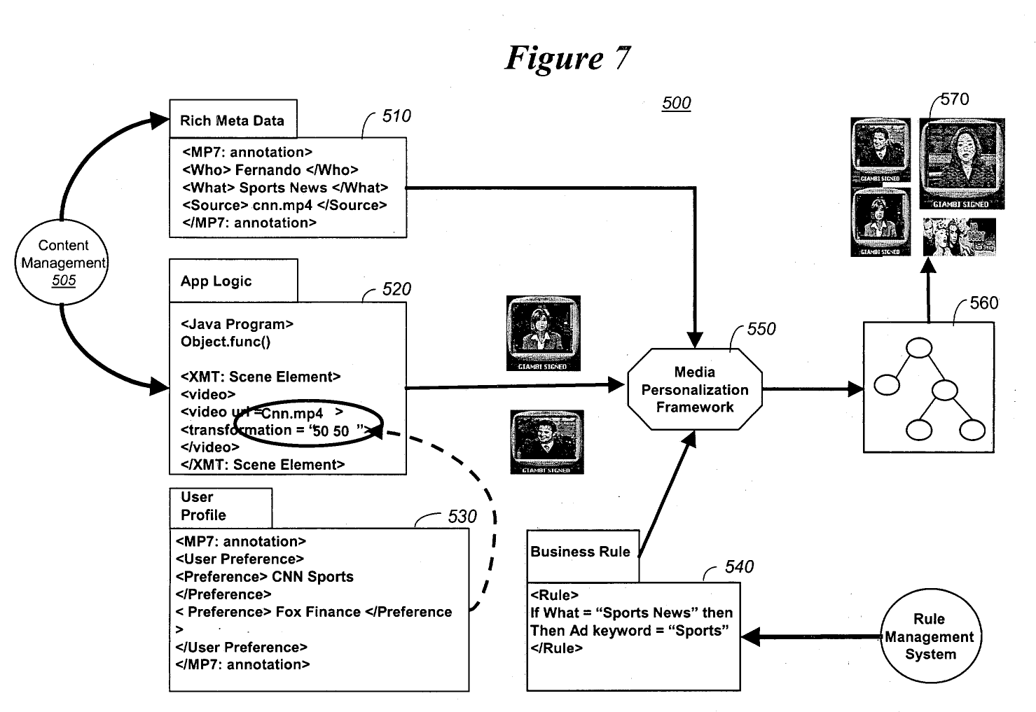

FIG. 7 is an exemplary diagram of the delivery of plurality of media content into a single media stream targeted at a specific audience in accordance with one embodiment of the invention.

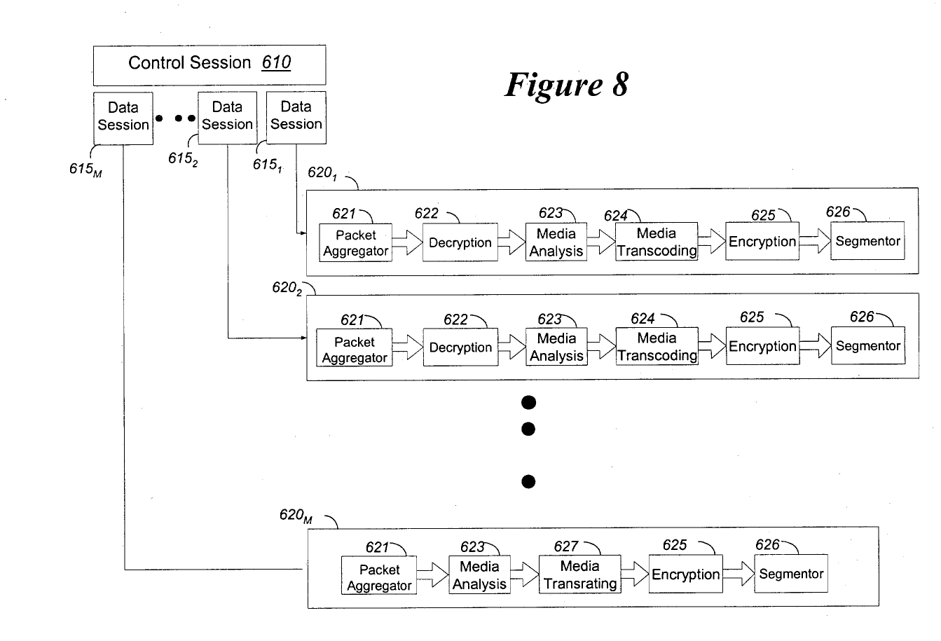

FIG. 8 is an exemplary embodiment of a media pipeline architecture featuring a plurality of process filter graphs deployed the media plane in the M-CE of FIG. 3.

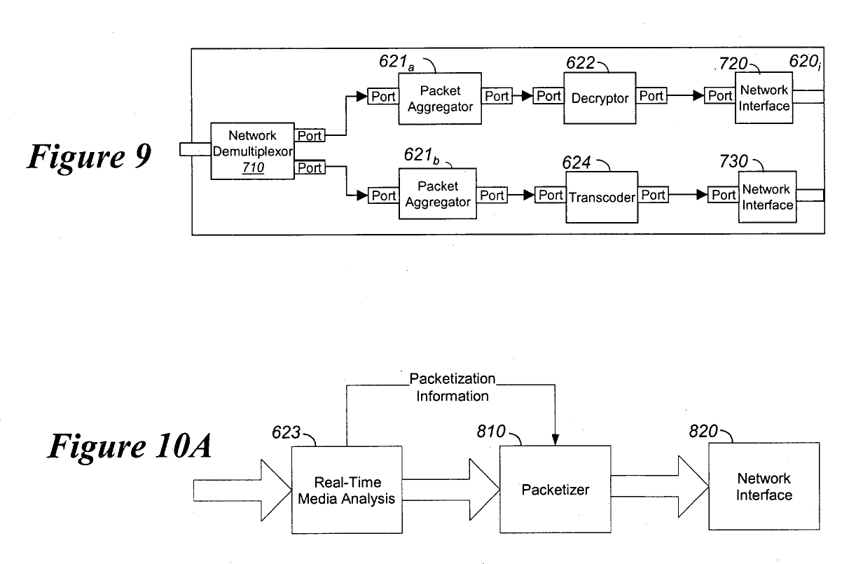

FIG. 9 is a second exemplary embodiment of a process filter graph configured to process video bit-streams within the Media Plane of the M-CE of FIG. 3.

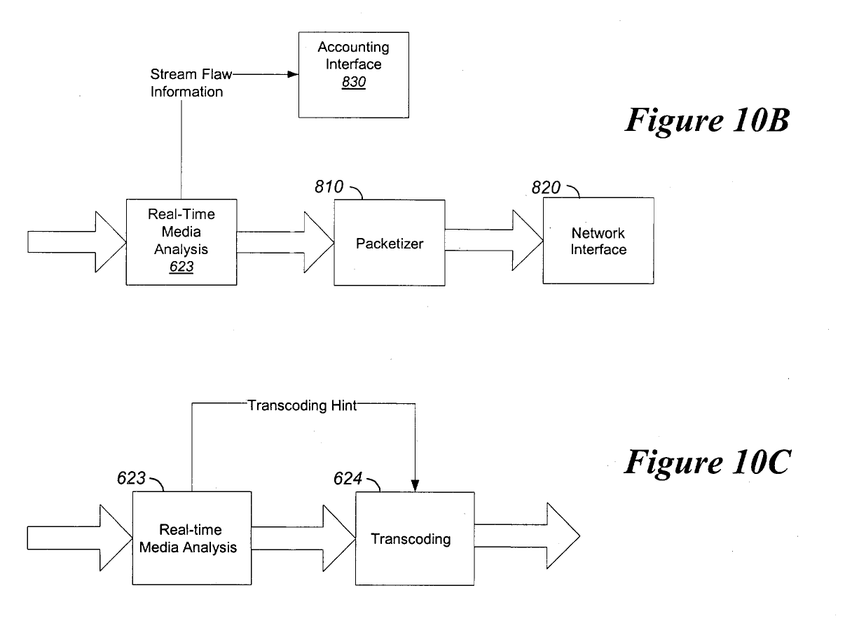

FIG. 10A is a first exemplary embodiment of additional operations performed by the media analysis filter of FIG. 8.

FIG. 10B is a second exemplary embodiment of additional operations performed by the media analysis filter of FIG. 8.

FIG. 10C is a third exemplary embodiment of additional operations performed by the media analysis filter of FIG. 8.

### DETAILED DESCRIPTION

In general, embodiments of the invention relate to a system, apparatus and method for receiving different types of media content at an edge of the network, perhaps over different delivery schemes, and transcoding such content for delivery as a single media stream to clients over a link. In one embodiment of the invention, before transmission to a client, media content from servers are collectively aggregated to produce multimedia content with a unified framework. Such aggregation is accomplished by application driven media processing and delivery modules. By aggregating the media content at the edge of the network prior to transmission to one or more clients, any delays imposed by the physical characteristics of the network over which the multimedia content is transmitted, such as delay caused by jitter, is uniformly applied to all media forming the multimedia content.

Certain details are set forth below in order to provide a thorough understanding of various embodiments of the invention, albeit the invention may be practiced through many embodiments other than those illustrated. Well-known components and operations may not be set forth in detail in order to avoid unnecessarily obscuring this description.

In the following description, certain terminology is used to describe features of the invention. For example, a “client” is a device capable of displaying video such as a computer, television, set-top box, personal digital assistant (PDA), or the like. A “module” is software configured to perform one or more functions. The software may be executable code in the form of an application, an applet, a routine or even a series of instructions. Modules can be stored in any type of machine readable medium such as a programmable electronic circuit, a semiconductor memory device including volatile memory (e.g., random access memory, etc.) or non-volatile memory (e.g., any type of read-only memory “ROM”, flash memory), a floppy diskette, an optical disk (e.g., compact disk or digital video disc “DVD”), a hard drive disk, tape, or the like.

A “link” is generally defined as an information-carrying medium that establishes a communication pathway. Examples of the medium include a physical medium (e.g., electrical wire, optical fiber, cable, bus trace, etc.) or a wireless medium (e.g., air in combination with wireless signaling technology). “Media content” is defined as information that at least comprises media data capable to being perceived by a user such as displayable alphanumeric text, audible sound, video, multidimensional (e.g. 2D/3D) computer graphics, animation or any combination thereof In general, media content comprises media data and perhaps (i) presentation to identify the orientation of the media data and/or (ii) meta-data that describes the media data. One type of media content is multimedia content being a combination of media content from multiple sources.

Referring now to FIG. 1, an illustrative block diagram of a media delivery system (MDS) 100 in accordance with one embodiment of the invention is shown. MDS 100 comprises an intelligent media content exchange (M-CE) 110, a provisioning network 120, and an access network 130. Provisioning network 120 is a portion of the network providing media content to MCE 110, including inputs from media servers 121. M-CE 110 is normally an edge component of MDS 100 and interfaces between provisioning network 120 and access network 130.

As shown in FIG. 1, for this embodiment, provisioning network 120 comprises one or more media servers 121, which may be located at the regional head-end 125. Media server(s) 121 are adapted to receive media content, typically video, from one or more of the following content transmission systems: Internet 122, satellite 123 and cable 124. The media content, however, may be originally supplied by a content provider such as a television broadcast station, video service provider (VSP), web site, or the like. The media content is routed from regional head-end 125 to a local head-end 126 such as a local cable provider.

In addition, media content may be provided to local head-end 126 from one or more content engines (CEs) 127. Examples of content engines 127 include a server that provides media content normally in the form of graphic images, not video as provided by media servers 121. A regional area network 128 provides another distribution path for media content obtained on a regional basis, not a global basis as provided by content transmission systems 122-124.

As an operational implementation, although not shown in FIG. 1, a separate application server 129 may be adapted within local head-end 126 to dynamically configure M-CE 110 and provide application specific information such as personalized rich media applications based on an MPEG-4 scene graphs, i.e., adding content based on the video feed contained in the MPEG-4 transmission. This server (hereinafter referred to as “M-server”) may alternatively be integrated within M-CE 110 or located so as to provide application specific information to local head-end 126 such as one of media servers 121 operating as application server 129. For one embodiment of the invention, M-CE 110 is deployed at the edge of a broadband content delivery network (CDN) of which provisioning network 120 is a subset. Examples of such CDNs include DSL systems, cable systems, and satellite systems. Herein, M-CE 110 receives media content from provisioning network 120, integrates and processes the received media content at the edge of the CDN for delivery as multimedia content to one or more clients 135₁-135_{N} (N≧1) of access network 130. One function of the M-CE 110 is to operate as a universal media exchange device where media content from different sources (e.g., stored media, live media) of different formats and protocols (e.g., MPEG-2 over MPEG-2 TS, MPEG-4 over RTP, etc.) can acquire, process and deliver multimedia content as an aggregated media stream to different clients in different media formats and protocols. An illustrative example of the processing of the media content is provided below.

Access network 130 comprises an edge device 131 (e.g., edge router) in communication with M-CE 110. The edge device 131 receives multimedia content from M-CE 110 and performs address translations on the incoming multimedia content to selectively transfer the multimedia content as a media stream to one or more clients 135₁, . . . , and/or 135_{N} (generally referred to as “client(s) 135ₓ) over a selected distribution channel. For broadcast transmissions, the multimedia content is sent as streams to all clients 135₁-135_{N}.

Referring to FIG. 2, an exemplary diagram of a screen display at client in accordance with one embodiment of the invention. Screen display 200 is formed by a combination of different types of media objects. For instance, in this embodiment, one of the media objects is a first screen area 210 that displays at a higher resolution than a second screen area 220. The screen areas 210 and 220 may support real-time broadcast video as well as multicast or unicast video.

Screen display 200 further comprises 2D graphics elements. Examples of 2D graphics elements include, but are not limited or restricted to, a navigation bar 230 or images such as buttons 240 forming a control interface, advertising window 250, and layout 260. The navigation bar 230 operates as an interface to allow the end-user the ability to select what topics he or she wants to view. For instance, selection of the “FINANCE” button may cause all screen areas 210 and 220 to display selected finance programming or cause a selected finance program to be displayed at screen area 210 while other topics (e.g., weather, news, etc.) are displayed at screen area 220.

The sources for the different types of media content may be different media servers and the means of delivery to the local head-end 125 of FIG. 1 may also vary. For example, video stream 220 displayed at second screen area 220 may be a MPEG stream, while the content of advertising window 250 may be delivered over Internet Protocol (IP).

Referring to both FIGS. 1 and 2, for this embodiment, M-CE 110 is adapted to receive from one or more media servers 121 a live news program broadcasted over a television channel, a video movie provided by a VPS, a commercial advertisement from a dedicated server or the like. In addition, M-CE 110 is adapted to receive another type of media content, such as navigator bar 230, buttons 240, layout 260 and other 2D graphic elements from content engines 127. M-CE 110 processes the different types of received media content and creates screen display 200 shown in FIG. 2. The created screen display 200 is then delivered to client(s) 135_{X} (e.g., television, a browser running on a computer or PDA) through access network 130.

The media content processing includes integration, packaging, and synchronization framework for the different media objects. It should be further noted that the specific details of screen display 200 may be customized on a per client basis, using a user profile available to M-CE 110 as shown in FIG. 5. In one embodiment of this invention, the output stream of the M-CE 110 is MPEG-4 or an H.261 standard media stream.

As shown, layout 260 is utilized by M-CE 110 for positioning various media objects; namely screen areas 210 and 220 for video as well as 2D graphic elements 230, 240 and 250. As shown, layout 260 features first screen area 210 that supports higher resolution broadcast video for a chosen channel being displayed. Second screen area 220 is situated to provide an end-user additional video feeds being displayed, albeit the resolution of the video at second screen area 220 may be lower than that shown at first screen area 210.

In one embodiment of this invention, the displayed buttons 240 act as a control interface for user interactivity. In particular, selection of an “UP” arrow or “DOWN” arrow channel buttons 241 and 242 may alter the display location for a video feed. For instance, depression of either the “UP” or “DOWN” arrow channel buttons 241 or 242 may cause video displayed in second screen area 220 to now be displayed in first screen area 210.

The control interface also features buttons to permit rudimentary control of the presentation of the multimedia content. For instance, “PLAY” button 243 signals M-CE 110 to include video selectively displayed in first screen area 210 to be processed for transmission to the access network 130 of FIG. 1. Selection of “PAUSE” button 244 or “STOP” button 245, however, signals M-CE 110 to exclude such video from being processed and integrated into screen display 200. Although not shown, the control interface may further include fast-forward and fast-rewind buttons for controlling the presentation of the media content.

It is noted that by placing M-CE 110 in close proximity to the end-user, the processing of the user-initiated signals (commands) is handled in such a manner that the latency between an interactive function requested by the end-user and the time by which that function takes effect is extremely short.

Referring now to FIG. 3, an illustrative diagram of M-CE 110 of FIG. 1 in accordance with one embodiment of the invention is shown. M-CE 110 is a combination of hardware and software that is segmented into different layers (referred to as “planes”) for handling certain functions. These planes include, but are not limited or restricted to two or more of the following: application plane 310, media plane 320, management plane 330, and network plane 340.

Application plane 310 provides a connection with M-server 129 of FIG. 1 as well as content packagers, and other M-CEs. This connection may be accomplished through a link 360 using a hypertext transfer protocol (HTTP) for example. M-server 129 may comprise one or more XMT based presentation servers that create personalized rich media applications based on an MPEG-4 scene graph and system frameworks (XMT-O and XMT-A). In particular, application plane 310 receives and parses MPEG-4 scene information in accordance with an XMT-O and XMT-A format and associates this information with a client session. “XMT-O” and “XMT-A” is part of the Extensible MPEG-4 Textual (XMT) format that is based on a two-tier framework: XMT-O provides a high level of abstraction of an MPEG-4 scene while XMT-A provides the lower-level representation of the scene. In addition, application plane 310 extracts network provisioning information, such as service creation and activation, type of feeds requested, and so forth, and sends this information to media plane 320.

Application plane 310 initiates a client session that includes an application session and a user session for each user to whom a media application is served. The “application session” maintains the application related states, such as the application template which provides the basic handling information for a specific application, such as the fields in a certain display format. The user session created in M-CE 110 has a one-to-one relationship with the application session. The purpose of the “user session” is to aggregate different network sessions (e.g., control sessions and data sessions) in one user context. The user session and application session communicate with each other using extensible markup language (XML) messages over HTTP.

Referring now to FIG. 4, an exemplary diagram of the functionality of the application plane 310 deployed within the M-CE 110 of FIG. 3 is shown. The functionality of M-CE 110 differs from traditional streaming device and application servers combinations, which are not integrated through any protocol. In particular, traditionally, an application server sends the presentation to the client device, which connects to the media servers directly to obtain the streams. In a multimedia application, strict synchronization requirements are imposed between the presentation and media streams. For example, in a distance learning application, a slide show, textual content and audio video speech can be synchronized in one presentation. The textual content may be part of application presentation, but the slide show images, audio and video content are part of media streams served by a media server. These strict synchronization requirements usually cannot be obtained by systems having disconnected application and media servers.

Herein, M-Server 129 of FIG. 1 (the application server) and the M-CE 110 (the streaming gateway) are interconnected via a protocol so that the application presentation and media streams can be delivered to the client in a synchronized way. The protocol between M-Server 129 and MCE 100 is a unified messaging language based on standard based descriptors from MPEG-4, MPEG-7 and MPEG-21 standards. The MPEG-4 provides the presentation and media description, MPEG-7 provides stream processing description such as transcoding and MPEG-21 provides the digital rights management information regarding the media content. The protocol between M-Server 129 and M-CE 110 is composed of MOML messages. MOML stands for MultiMedia Object Manipulation Language. Also, multimedia application presentation behavior changes as user interacts with the application, such as based on user interaction the video window size can increase or decrease. This drives media processing requirements in M-CE 110. For example, when the video window size decreases, the associated video can be scaled down to save bandwidth. This causes a message, such as media processing instruction, to be sent via protocol from M-Server 129 to M-CE 110.

Application plane 310 of M-CE 110 parses the message and configures the media pipeline to process the media streams accordingly. As shown in detail in FIG. 4, application plane 310 comprises an HTTP server 311, a MOML parser 312, an MPEG-4 XMT parser 3113, an MPEG-7 parser 314, an MPEG-21 parser 315 and a media plane interface 316. In particular, M-server 129 transfers a MOML message (not shown) to HTTP server 311. As an illustrative embodiment, the MOML message contains a presentation section, a media processing section and a service rights management section (e.g., MPEG-4 XMT, MPEG-7 and MPEG-21 constructs embedded in the message). Of course, other configurations of the message may be used.

HTTP server 311 routes the MOML message to MOML parser 312, which extracts information associated with the presentation (e.g. MPEG-4 scene information and object descriptor “OD”) and routes such information to MPEG-4 XMT parser 313. MPEG-4 XMT parser 313 generates commands utilized by media plane interface 316 to configure media plane 320.

Similarly, MOML parser 312 extracts information associated with media processing from the MOML message and provides such information to MPEG-7 parser 314. Examples of this extracted information include a media processing hint related to transcoding, transrating thresholds, or the like. This information is provided to MPEG-7 parser 314, which generates commands utilized by media plane interface 316 to configure media plane 320.

MOML parser 312 further extracts information associated with service rights management data such policies for the media streams being provided (e.g., playback time limits, playback number limits, etc.). This information is provided to MPEG-21 parser 315, which also generates commands utilized by media plane interface 316 to configure media plane 320.

Referring to FIGS. 3 and 5, media plane 320 is responsible for media stream acquisition, processing, and delivery. Media plane 320 comprises a plurality of modules; namely, a media acquisition module (MAM) 321, a media processing module (MPM) 322, and a media delivery module (MDM) 323. MAM 321 establishes connections and acquires media streams from media server(s) 121 and/or 127 of FIG. 1 as perhaps other M-CEs. The acquired media streams are delivered to MPM 322 and/or and MDM 323 for further processing. MPM 322 processes media content received from MAM 321 and delivers the processed media content to MDM 323. Possible MPM processing operations include, but are not limited or restricted to transcoding, transrating (adjusting for differences in frame rate), encryption, and decryption.

MDM 323 is responsible for receiving media content from MPM 322 and delivering the media (multimedia) content to client(s) 135_{X} of FIG. 1 or to another M-CE. MDM 323 configures the data channel for each client 135₁-135_{N}, thereby establishing a session with either a specific client or a multicast data port. Media plane 320, using MDM 323, communicates with media server(s) 121 and/or 127 and client(s) 135_{X} through communication links 350 and 370 where information is transmitted using Rapid Transport Protocol (RTP) and signaling is accomplished using Real-Time Streaming Protocol (RTSP).

As shown in FIG. 5, media manager 324 is responsible to interpret all incoming information (e.g., presentation, media processing, service rights management) and configure MAM 321, MPM 322 and MDM 323 via Common Object Request Broker Architecture (CORBA) API 325 for delivery of media content from any server(s) 121 and/or 127 to a targeted client 135_{X}.

In one embodiment, MAM 321, MPM 322, and MDM 323 are self-contained modules, which can be distributed over different physical line cards in a multi-chassis box. The modules 321-323 communicate with each other using industry standard CORBA messages over CORBA API 326 for exchanging control information. The modules 321-323 use inter-process communication (IPC) mechanisms such as sockets to exchange media content. A detailed description for such architecture is shown in FIG. 6.

Management plane 330 is responsible for administration, management, and configuration of M-CE 110 of FIG. 1. Management plane 330 supports a variety of external communication protocols including Signaling Network Management Protocol (SNMP), Telnet, Simple Object Access Protocol (SOAP), and Hypertext Markup Language (HTML).

Network plane 340 is responsible for interfacing with other standard network elements such as routers and content routers. Mainly, network plane 340 is involved in configuring the network environment for quality of service (QoS) provisioning, and for maintaining routing tables.

The architecture of M-CE 110 provides the flexibility to aggregate unicast streams, multicast streams, and/or broadcast streams into one media application delivered to a particular user. For example, M-CE 110 may receive multicast streams from one or more IP networks, broadcast streams from one or more satellite networks, and unicast streams from one or more video server, through different MAMs. The different types of streams are served via MDM 323 to one client in a single application context.

It should be noted that the four functional planes of M-CE 110 interoperate to provide a complete, deployable solution. However, although not shown, it is contemplated that M-CE 110 may be configured without the network 340 where no direct network connectivity is needed or without management plane 330 if the management functionality is allocated into other modules.

Referring now to FIG. 6, an illustrative diagram of M-CE 110 of FIG. 1 configured as a blade-based MPEG-4 media delivery architecture 400 is shown. For this embodiment, media plane 320 of FIG. 3 resides in multiple blades (hereinafter referred to as “line cards”). Each line card may implement one or more modules.

For instance, in this embodiment, MAM 321, MPM 322, and MDM 323 reside on separate line cards. As shown in FIG. 6, MAMs reside on line cards 420 and 440, MDM 323 resides on line card 430, and MPM 322 is located on line card 450. In addition, application plane 310 and management plane 330 of FIG. 3 reside on line card 410, while network plane 340 resides on line card 460. This separation allows for easier upgrading and troubleshooting.

Each line card 410, . . . , or 460 may have different functionality. For example, one line card may operate as an MPEG-2 transcode or MPEG-2 TS media networking stack with DVB-ASI input for MAM, while another line card may have gigabit-Ethernet input with RTP/ RTSP media network stack for the MAM. Based on the information provided during session setup, appropriate line cards are chosen for the purpose of delivering the required media (multimedia) content to an end-user or a group of end-users.

It is contemplated, however, that more than one module may reside on a single line card. It is further contemplated that the functionality of M-Server 129 may be implemented within one or more of line cards 410-460 or within a separate line card 490 as shown by dashed lines.

Still referring to FIG. 6, line cards 410-460 are connected to a back-plane 480 via bus 470. The back-plane enables communications with clients 135₁-135_{N} and local head-end 126 of FIG. 1. Bus 470 could be implemented, for example, using a switched ATM or Peripheral Component Interconnect (PCI) bus. Typically, the different line cards 410-460 communicate using an industry standard CORBA protocol and exchange media content using a socket, shared memory, or any other IPC mechanism.

Referring to FIG. 7, a diagram of the delivery of multiple media contents into a single media stream targeted at a specific audience is shown. Based on user specific information 560 stored internally within MC-E 110 or acquired externally (e.g., from M-Server as line card or via local head-end), the media personalization framework 550 gathers the media content required to satisfy the needs of an end-user to create multimedia content 570, namely screen display 200 of FIG. 2, streamed to the end-user. The “user specific information” identifies the media objects desired as well as the topology in time and space.

The user preferences may be provided as shown in a user profile 530, which are code fragments derived from the specific end-user or group of end-users' profiles to customize the various views that will be provided. For example, an end-user may have preferences to view the sports from one channel and financial news from another.

The content management 505 is code fragments derived to manage the way media content is provided, be it rich media (e.g., text, graphics, etc.) or applications such as scene elements. Herein, for this embodiment, application logic 520 uses the user preferences from the user profile 530 to organize the media objects. Using the application logic 520 and rich meta data 510 allows the combination of the media content 510 with the user information 560 to provide the desired data.

In addition, certain business rules 540 may be applied to allow a provider to add content to the stream provided to the end-user or a group of end-users. For example, business rules 540 can be used to provide a certain type of advertisements if the sports news are displayed. It is the responsibility of the various layers of the M-CE to handle these activities for providing the enduser with the desired stream of media (multimedia) content.

As shown in FIG. 8, an exemplary embodiment of the media plane pipeline architecture of M-CE 110 of FIG. 3 is shown. The media plane pipeline architecture needs to be flexible, namely it should be capable of being configured for many different functional combinations. For an illustrative example, in an IP based VoD service, an encrypted MPEG-2 media is transcoded in MPEG-4 and delivered to the client in an encrypted form. This would require a processing filter for MPEG-TS demultiplexing, a filter for decryption of media content, a filter for transcoding of MPEG-2 to MPEG-4, then one filter for re-encrypting the media content. M-CE 110 uses four filters and links them together to form a solution for this application.

As one embodiment of the invention, the media plane pipeline architecture comprises one or more process filter graphs (PFGs) 620₁-620_{M} (M≧1) deployed in MAM 321 and/or MPM 322 of the M-CE 110 of FIG. 3. Each PFG 620₁, . . . , or 620_{M} is dynamically configurable and comprises a plurality of processing filters in communication with to each other, each of the filters generally performing a processing operation. The processing filters include, but are not limited to, a packet aggregator filter 621, real-time media analysis filter 623, a decryption filter 622, an encryption filter 625, and a transcoding filter 624.

As exemplary embodiments, filters 621-624 of PFG 620, may be performed by MAM 321 while filters 625-626 are performed by MPM 322. For another embodiment, filter 621 for PFG 620_{M} may be performed by MAM 321 while filters 623, 625 and 626 are performed by MPM 322. Different combinations may be deployed as a load balancing mechanism.

Referring still to FIG. 8, M-CE 110 processes the media content received from a plurality of media sources, using PFGs 620₁-620_{M}. Each PFG 620₁, . . . , or 620_{M} is associated with a particular data session 615₁-615_{M}, respectively. Each of data sessions 615₁, . . . , or 615_{M} aggregates the channels through which the incoming media content flows. Control session 610 aggregates and manages data sessions 615₁-615_{M}. Control session 610 provides an interface, which is control, protocol-based (e.g. RTSP) to control the received media streams.

As an illustrative embodiment, PFG 620₁ comprises a sequence of processing filters 621-626 coupled with each other via a port. The port may be a socket, shared buffer, or any other interprocess communication mechanisms. The processing filters 621-626 are active elements executing in their own thread context. For example, packet aggregator filter 621 receives media packets and reassembles the payload data of the received packets into an access unit (AU). “AU” is a decodable media payload containing sufficient contiguous media content to allow processing. Decryption filter 622 decrypts the AU and media transcoding filter 624 transcodes the AU. The encryption and segmentor filters 625 and 626 are used to encrypt the transmitted media and arrange the media according to a desired byte (or packet) structure.

Another processing filter is the real-time media analysis filter 623, which is capable of parsing, in one embodiment, MPEG-4 streams, generating transcoding hints information, and detecting stream flaws. Real-time media analysis filter 623 may be used in one embodiment of this invention and is described in greater detail in FIGS. 10A-10C.

The processing filters 621-626 operate in a pipelined fashion, namely each processing filter is a different processing stage. The topology of each PFG 620₁, . . . , or 620_{M}, namely which processing filters are utilized, is determined when the data session 615₁, . . . , or 615_{M} is established. Each of PFGs 620₁, . . . , or 620_{M} may be configured according to the received media content and the required processing, which makes PFG 620₁, . . . , or 620_{M} programmable. Therefore, PFGs may have different combination of processing filters. For instance, PFG 620_{M} may features a media transrating filter 627 to adjust frame rate of received media without a decryption or transcoding filter, unlike PFG 620₁.

For example, in case of transmission of scalable video from a server, it is contemplated that the base layer may be encrypted, but the enhanced layers carry clear media or media encrypted using another encryption algorithm. Consequently, the process filter sequence for handling the base layer video stream will be different from the enhanced layer video stream.

As shown in FIG. 9, for this exemplary embodiment, process filter graph (PFG) 620₁ (1≦i ≦M) is configured to process video bit-streams is shown. PFG 620ᵢ includes network demultiplexer filter 710, packet aggregator filters 621a and 621b, decryption filter 622, transcoding filter 624, and network interface filters 720 and 730. The network demultiplexer filter 710 determines whether the incoming MPEG-4 media is associated with a base layer or an enhanced layer. The network interface filters 720 and 730 prepare the processed media for transmission (e.g., encryption filter if needed, segmentor filter, etc.).

The base layer, namely the encrypted layer in the received data, flows through packet aggregator filter 621a, decryption filter 622, and network interface filter 720. However, any enhanced layers flow through aggregator filter 621b, transcoding filter 624, and network interface filter 730.

It should be noted that PFGs 620₁, . . . , or 620_{M} can be changed dynamically even after establishing a data session. For instance, due to a change in the scene, it may be necessary to insert a new processing filter. It should be further noted that, for illustrative sake, PFG 620ᵢ and the processing filters are described herein to process MPEG-4 media streams, although other types of media streams may be processed in accordance with the spirit of the invention.

Referring now to FIGS. 10A-10C, various operations of a real-time media analysis filter 623 in PFG 620ᵢ are shown. Media analysis filter 623 provides functionalities, such as parsing and encoding incoming media streams, as well as generating transcoding hint information.

Media analysis filter 623 of FIG. 10A is used to parse video bit-stream in real-time and to generate boundary information. The boundary information includes slice boundary, MPEG-4 video object layer (VOL) boundary, or macro-block boundary. This information is used by packetizer 810 (shown as “segmentor filter” 626 of FIG. 8) to segment the AU. Considering slice boundary, VOL boundary, macro-block boundary in AU segmentation ensures that video stream can be reconstructed more accurately with greater quality in case of packet loss. The processed video stream is delivered to client(s) 135_{X} through network interface filter 820.

Media analysis filter 623 of FIG. 10B is used for stream flaw detection. Media analysis filter 623 parses the incoming media streams and finds flaws in encoding. “Flaws” may include, but are not limited to bit errors, frame dropouts, timing errors, and flaws in encoding. The media streams may be received either from a remote media server or from a real-time encoder. If media analysis filter 623 detects any flaw, it reports the flaw to accounting interface 830. Data associated with the flaw is logged and may be provided to the content provider. In addition, the stream flow information can be transmitted to any real-time encoder for the purpose of adjusting the encoding parameters to avoid stream flaws, if the media source is a real-time encoder. In one embodiment the media is encoded, formatted, and packaged as MPEG-4.

Media analysis filter 623 of FIG. 10C is used to provide transcoding hint information to transcoder filter 624. This hint information assists the transcoding in performing a proper transcode from one media type to another. Examples of “hint information” includes frame rate, frame size (in a measured unit) and the like.

While the invention has been described in terms of several embodiments, the invention should not limited to only those embodiments described, but can be practiced with modification and alteration within the spirit and scope of the appended claims. The description is thus to be regarded as illustrative instead of limiting. Inclusion of additional information set forth in the provisional applications is attached as Appendices A and B for incorporation by reference into the subject application.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An apparatus positioned at an edge of a network, comprising:
a bus;
a first line card coupled to the bus; and
a second line card coupled to the bus, the second line card adapted to handle acquisition of at least two different types of media content from different sources and to process the at least two different types of media content in order to integrate the at least two different types of media content into a single stream of media content.

2. The apparatus of claim 1 further comprising a third line card in communication with the second line card, the third line card being adapted for delivery of the single stream of media content to a remotely located client.

3. The apparatus of claim 2 being positioned at an edge of a content delivery network for transmission of the single stream of media content to the remotely located client.

4. The apparatus of claim 1, wherein the first line card is an application plane comprising a first parser to extract and separately route (1) information associated with presentation and (2) information associated with media processing.

5. The apparatus of claim 4, wherein the first parser of the application plane further extracting and separately routing service rights management data.

6. The apparatus of claim 5, wherein the first line card further comprises an interface and a plurality of parsers coupled to the first parser and the interface, the plurality of parsers generating commands for configuring functionality of the second line card.

7. The apparatus of claim 1 further comprising a back plane switch fabric coupled to the bus.

8. A method for integrating media content from a plurality of sources into a single media stream, the method comprising:
receiving incoming media content from the plurality of sources at an edge of a network;
processing the incoming media content into the single media steam at the edge of the network; and
delivering the media stream to a plurality of clients.

9. The method of claim 8, wherein the receiving of the media content comprises:
receiving a message with a data structure including information associated with presentation of the incoming media content and media processing hints; and
parsing the message to extract the information associated with the presentation of the incoming media content and the media processing hints to generate commands to establish a media processing pipeline of filters for processing the incoming media content.

10. The method of claim 9, wherein the media processing pipeline comprises a plurality of filters for processing the incoming media content and outputting outgoing media content, the plurality of filters includes a packet aggregator filter to aggregate incoming media content.

11. The method of claim 10, wherein the plurality of filters further comprises a transcoding filter to transcode the incoming media content of a first format into the outgoing media content having a second format differing from the first format.

12. The method of claim 11, wherein the first format is MPEG-2 and the second format is MPEG-4.

13. The method of claim 11, wherein the plurality of filters further comprises a transrating filter to adjust a transfer frame rate from a difference between the incoming media content and the outgoing media content.

14. The method of claim 11, wherein the plurality of filters further comprises a decryption filter to decrypt the incoming media content.

15. The method of claim 14, wherein the plurality of filters further comprises an encryption filter to encrypt the outgoing media content.

16. Stored in a machine readable medium and executed by a processor positioned at an edge of a network, application driven software comprising:
a first module to handle acquisition of at least two different types of media content from different sources; and
a second module to process the at least two different types of media content in order to integrate the at least two different types of media content into a single stream of media content.

17. The application driven software of claim 16 further comprising a third module to deliver the single stream of media content to a remotely located client.

18. The application driven software of claim 17 further comprising a media manager to interpret incoming information received by an application server and to configure the first, second and third modules via a Common Object Request Broker Architecture (CORBA) API.

19. The application driven software of claim 17, wherein the first, second and third modules exchange control information using Common Object Request Broker Architecture (CORBA) messages. The modules 321-323 use inter-process communication (IPC) mechanisms such as sockets to exchange media content.

20. The application driven software of claim 17, wherein the first, second and third modules exchange media content using inter-process communication (IPC) mechanisms inclusive of sockets.
